(19) United States
(12) Patent Application Publication
(10) Pub. No.: US 2011/0274178 A1
(43) Pub. Date: Nov. 10, 2011

(54) METHOD AND DEVICE FOR PARALLEL DECODING OF VIDEO DATA UNITS

(75) Inventors: Patrice Onno, Rennes (FR); Fabrice Le Leannec, Mouaze (FR); Julien Ricard, Rennes (FR); Gordon Clare, Pace (FR)

(73) Assignee: CANON KABUSHIKI KAISHA, Tokyo (JP)

(21) Appl. No.: 12/775,086

(22) Filed: May 6, 2010

(51) Int. Cl. H04N 7/26

(52) U.S. Cl. 375/240.25; 375/E07.027

(57) ABSTRACT

The present invention comprises a method for controlling a decoder, and a decoder for decoding a video data stream that comprises a plurality of video data units. The decoder comprises: a plurality of decoder units configured to carry out a plurality of decoding tasks on said video data units; a video data dispatcher configured to allocate each video data unit to a respective decoder unit in accordance with at least one decoding constraint; and a controller configured to: determine from the decoding constraints which decoding tasks may be performed on a current video data unit; control the allocation by the video data dispatcher of the current video data unit to a decoder unit based on the determination result; and perform the determining and controlling step for each video data unit such that a plurality of decoding tasks on a plurality of video data units are carried out in parallel. The performing of the decoding tasks in parallel has the advantage of decreasing the amount of time taken to decode the video data stream.

### CROSS-REFERENCE TO RELATED APPLICATION

Not applicable

### BACKGROUND OF THE INVENTION

The present invention relates to decoders for decoding video data such as video streams of the SVC type. In particular, the present invention relates to H.264 decoders, including scalable video coding (SVC) decoders and their architecture, and to the decoding tasks that are carried out on the video data encoded using the H.264/SVC specification.

H.264/AVC (Advanced Video Coding) is a standard for video compression providing good video quality at a relatively low bit rate. It is a block-oriented compression standard using motion-compensation algorithms. In other words, the compression is carried out on video data that has effectively been divided into blocks, where a plurality of blocks usually makes up a video frame. The compression method uses algorithms to describe video data in terms of a transformation from a reference picture to a current picture. More specifically, as both the reference picture and the current picture are made of a plurality of blocks, a reference block is compared with a current block and a transformation between them determined in order to define the current block in these terms. The standard has been developed to be easily used in a wide variety of applications and conditions.

An extension of H.264/AVC is SVC (Scalable Video Coding) which encodes a high quality video bitstream by dividing it into a plurality of scalability layers containing subset bitstreams. Each subset bitstream is derived from the main bitstream by filtering out parts of the main bitstream to give rise to subset bitstreams of lower spatial or temporal resolution or lower quality video than the full high quality video bitstream. Those subset bitstreams can be read directly and can be decoded with an H.264/AVC decoder. In this way, if bandwidth becomes limited, individual bitstreams can be discarded, merely causing a less noticeable degradation of quality rather than complete loss of picture.

Functionally, the compressed video comprises a base layer containing basic video information, and enhancement layers that provide additional information about quality, resolution or frame rate. It is these enhancement layers that may be discarded in the finding of a balance between good compression (to give a small file size) and high quality video data.

The algorithms that are used for compressing the video data stream deal with transformation performed on or between video frames that are called picture types or frame types. The three main frame types are I, P and B frames.

An I-frame is an “Intra-coded picture” and contains all of the information required to display a picture. I-frames are the least compressible of the frame types but do not require other types of frames in order to be decoded and produce a full picture.

A P-frame is a “predicted picture” and usually holds the differences in the picture from the previous frame. P-frames can use data from previous frames to be decompressed and are more compressible than I-frames for this reason.

A B-frame is a “Bi-predictive picture” and holds differences between the current picture and both the preceding and following pictures to specify its content. As B-frames can use both preceding and succeeding frames for data reference to be decompressed, B-frames are the most compressible of the frame types. P- and B-frames are collectively referred to as “Inter” frames.

Pictures may be divided into slices. A slice is a spatially distinct region of a picture that is encoded separately from other regions of the same picture. Furthermore, pictures can be segmented into macroblocks. A macroblock is a type of block referred to above and may comprise, for example, each 16×16 array of pixels of each coded picture in the base layer. I-pictures contain only I-macroblocks. P-pictures may contain either I-macroblocks or P-macroblocks and B-pictures may contain any of I-, P- or B-macroblocks. Sequences of macroblocks may make up slices.

Pictures or frames may be individually divided into the base and enhancement layers described above.

Inter-macroblocks (i.e. P- and B-macroblocks) correspond to a specific set of macroblocks that are formed in block shapes specifically for motion-compensated prediction. In other words, the size of macroblocks in P- and B-pictures is chosen in order to optimise the prediction of the data in that macroblock based on the extent of the motion of features in that macroblock compared with previous and/or subsequent macroblocks.

When a video bitstream is being manipulated (e.g. transmitted or encoded, etc.), it is useful to have a means of containing and identifying the data. To this end, a type of data container used for the manipulation of the video data is a unit called a Network Abstraction Layer unit (NAL unit or NALU). A NAL unit—rather than being a physical division of the picture as the macroblocks described above are—is a syntax structure that contains bytes representing data and an indication of a type of that data (e.g. whether the data is the video or other related data). Different types of NAL unit may contain coded video data or information related to the video. Each enhancement layer corresponds to a set of identified NAL units. A set of successive NAL units that contribute to the decoding of one picture forms an Access Unit (AU).

FIG. 1 illustrates a typical decoder 100 attached to a network 34 for communicating with other devices on the network. The decoder 100 may take the form of a computer, a mobile (cell) telephone, or similar. The decoder 100 uses a communication interface 118 to communicate with the other devices on the network (other computers, mobile telephones, etc.). The decoder 100 also has optionally attachable or attached to it a microphone 124, a floppy disk 116 and a digital card 101, via which it receives auxiliary information such as information regarding a user's identification or other security-related information, and/or data processed (in the floppy disk or digital card) or to be processed by the decoder. The decoder itself contains interfaces with each of the attachable devices mentioned above; namely, an input/output 122 for audio data from the microphone 124 and a floppy disk interface 114 for the floppy disk 116 and the digital card 101. The decoder will also have incorporated in, or attached to, it a keyboard 110 or any other means such as a pointing device, for example, a mouse, a touch screen or remote control device, for a user to input information; and a screen 108 for displaying video data to a user or for acting as a graphical user interface. A hard disk 112 will store video data that is processed or to be processed by the decoder. Two other storage systems are also incorporated into the decoder, the random access memory (RAM) 106 or cache memory for storing registers for recording variables and parameters created and modified during the execution of a program that may be stored in a read-only memory (ROM) 104. The ROM is generally for storing information required by the decoder for decoding the video data, including software for controlling the decoder. A bus 102 connects the various devices in the decoder 100 and a central processing unit (CPU) 103 controls the various devices.

FIG. 2 is a conceptual diagram of the SVC decoding process that applies to an SVC bitstream 200 made, in the present case, of three scalability layers. More precisely, the SVC bitstream 200 being decoded in FIG. 2 is made of one base layer, a spatial enhancement layer, and an SNR (signal to noise ratio) enhancement layer (or quality layer) on top of the spatial layer. Therefore, the SVC decoding process comprises three stages, each of which handles items of data of the bitstream according to the layer to which they belong. To that end, a demultiplexing operation 202 is performed by a demultiplexer on the received items of data to determine in which stage of the decoding method they should be processed.

The first stage (with suffix a in the reference numerals) illustrated in FIG. 2 concerns the base layer decoding process that starts by the parsing and entropy decoding 204a of each macroblock within the base layer. The entropy decoding process provides a coding mode, motion data and residual data. The motion data contains reference picture indexes for Inter-coded macroblocks (i.e. an indication of which pictures are the reference pictures for a current picture including the Inter-coded macroblocks) and motion vectors defining transformation from the reference-picture macroblocks to the current Inter-coded macroblocks. The residual data consists of the difference between the macroblock to be decoded and the reference macroblock (from the reference picture) indicated by the motion vector, which has been transformed using a direct cosine transform (DCT) and quantized during the encoding process. This residual data can be stored as the encoded data for the current macroblock, as the rest of the information defining the current macroblock is available from the reference macroblock.

This same parsing and entropy decoding step 204b, 204c is also performed to the two enhancement layers, in the second (b) and third (c) stages of the process.

Next, in each stage (a,b,c), the quantized DCT coefficients that have been revealed during the entropy decoding process 204a, 204b, 204c undergo inverse quantization and inverse transform operations 206a, 206b, 206c. In the example of FIG. 2, the second layer of the stream has a higher spatial resolution than the base layer. In this case, the inverse quantization and transform is fully performed to the base layer. Specifically, in SVC, the residual data is completely reconstructed in layers that precede a resolution change because the texture data has to undergo a spatial up-sampling process. Thus, the inverse quantization and transform is performed on the base layer to reconstruct the residual data in the base layer as it precedes a resolution change (to a higher spatial resolution) in the second layer.

The Inter-layer prediction and texture refinement process are applied directly on quantized coefficients without performing inverse quantization in the case of a quality enhancement layer (c). The Inter layer predication from a lower layer can be used for Intra prediction/decoding 210a, 210b and 210c, which all carry out the Intra prediction/decoding of the I-macroblocks in the same way. In FIG. 2, the output of the Inter layer prediction result from the lower layer being input into the respective Intra prediction step is represented by the switch 230 being connected to the top-most connection.

The reconstructed residual data is then stored in the frame buffers 208a, 208b, 208c in each stage. Intra-coded macroblocks are fully reconstructed through the well-known spatial Intra-prediction techniques 210a, 210b, 210c.

With reference specifically to the first stage (a) of processing the base layer, the decoded motion and temporal residual data for Inter-macroblocks and the reconstructed Intra-macroblocks, are stored into a frame buffer 208a of the SVC decoder of FIG. 2. Such a frame buffer contains the data that can be used as reference data to predict an upper scalability layer.

To improve the visual quality of decoded video, a deblocking filter 212, 214 is applied for smoothing sharp edges formed between decoded blocks. The goal of the deblocking filter, in an H.264/AVC or SVC decoder, is to reduce the blocking artifacts that may appear on the boundaries of decoded blocks. It is a feature on both the decoding and encoding paths, so that in-loop effects of the deblocking filter are taken into account in the reference macroblocks.

The Inter-layer prediction process of SVC applies a so-called Intra-deblocking operation 212 on Intra-macroblocks reconstructed from the base layer of FIG. 2 (note that no prediction is carried out for the encoding of Intra-macroblocks). The Intra-deblocking consists of filtering the blocking artifacts that may appear at the boundaries of reconstructed Intra-macroblocks. This Intra deblocking operation occurs in the Inter-layer prediction process only when a spatial resolution change occurs between two successive layers (so that the full Inter-layer is available prior to the resolution change). This may, for example, be the case between the first (base) and second (enhancement) layers in FIG. 2.

With reference specifically to the second stage (b) of FIG. 2, the decoding is performed on a spatial enhancement layer on top of the base layer decoded by the first stage (a). This spatial enhancement layer decoding involves the parsing and entropy decoding of the second layer, which provides the motion information as well as the transformed and quantized residual data for macroblocks of the second layer. With respect to Inter-macroblocks, as the next layer (third layer) has the same spatial resolution as the second one, their residual data only undergoes the entropy decoding step and the result is stored in the frame memory buffer 208b associated with the second layer of FIG. 2. A residual texture refinement process is performed in the transform domain between quality layers in SVC. There are two types of quality layers currently defined in SVC, namely CGS layers (Coarse Grain Scalability) and MGS layers (Medium Grain Scalability).

Concerning Intra-macroblocks, their processing depends upon their type. In case of Inter-layer-predicted Intra-macroblocks (using the I_BL coding mode that produces Intra-macroblocks using the Inter-layer predictions described above), the result of the entropy decoding is stored in the respective frame memory buffer 208a, 208b and 208c. In the case of a non I_BL Intra-macroblock, such a macroblock is fully reconstructed through inverse quantization and inverse transform 206 to obtain the residual data in the spatial domain, and then Intra-predicted 210a, 210b, 210c.

Finally, the decoding of the third layer of FIG. 2, which is also the top-most layer of the presently-considered bitstream, involves a motion compensated (218) temporal prediction loop. The following successive steps are performed by the decoder to decode the sequence at the top-most layer. These steps may be summed up as parsing & decoding; reconstruction; deblocking and interpolation.

Each macroblock first undergoes a parsing and entropy decoding process 204c which provides motion and texture residual data. If Inter-layer residual prediction data is used for the current macroblock, this quantized residual data is used to refine the quantized residual data issued from the reference layer. This is shown by the bottom connection of switch 232. Texture refinement is performed in the transform domain between layers that have the same spatial resolution.

A reconstruction step is performed by applying an inverse quantization and inverse transform 206c to the optionally refined residual data. This provides reconstructed residual data. In the case of Inter-macroblocks, the decoded residual data refines the decoded residual data that issued from the base layer if inter-layer residual prediction was used to encode the second scalability layer.

In the case of Intra-macroblocks, the decoded residual data is used to refine the prediction of the current macroblock. If the current macroblock is I_BL (i.e. if it was coded in I_BL mode), then the decoded residual data can be used to further refine the residual data of the base macroblock.

The decoded residual data is then added to the temporal, Intra-layer or Inter-layer Intra-prediction macroblock of the current macroblock, to provide the reconstructed macroblock. The I_BL Intra-macroblocks are output from the Inter-layer prediction and this output is represented by the arrow from the deblocking filter 212 to the tri-connection switch 230. For the Intra-macroblocks, residual data is applied to the traditional Intra prediction mode or to the I_BL macroblocks.

The reconstructed macroblock undergoes a so-called full deblocking filtering process 214, which is applied both to Inter- and Intra-macroblocks. This is in contrast to the deblocking filter 212 applied in the base layer which is applied only to Intra-macroblocks.

The full deblocked picture is then stored in the Decoded Picture Buffer (DPB), represented by the frame memory 208c in FIG. 2, which is used to store pictures that will be used as references to predict future pictures to decode. The decoded pictures are also ready to be displayed on a screen.

Then frames in the DPB are interpolated when they are used for reference for the reconstruction of future frames which are obtained by a sub-pixel motion compensation process.

The deblocking filters 212, 214 are filters applied in the decoding loop, and they are designed to reduce the blocking artifacts and therefore to improve the visual quality of the decoded sequence. For the topmost decoded layer, the full deblocking comprises an enhancement filter applied to all blocks with the aim of improving the overall visual quality of the decoded picture. This full deblocking process, which is applied on complete reconstructed pictures, is the same adaptive deblocking process specified in the H.264/AVC compression standard.

US 2008/010784 A1 describes video decoding using a multithread processor. This document describes analyzing the temporal dependencies between images in terms of reference frames through the slice type to allocate time slots. Frames of the video data are read and decoded in parallel in different threads. Temporal dependencies between frames are analyzed by reading the slice headers. Time slots are allocated during which the frames are read or decoded. Different frames contain different amounts of data and so even though all tasks are started at the same time (at the beginning of a time slot), some tasks can be performed faster than others. Threads processing faster tasks will therefore stand idle while slower tasks are processed.

Generally, SVC or H.264 bitstreams are organized in the order in which they will be decoded. This means that in the case of a sequential decoding (NALU per NALU), decoding in a single elementary decoder means that the content does not need to be analyzed. This is the case of the JSVM reference software for SVC and for the JM reference software of H.264.

The problem with the above-described methods is that the elementary decoders are idle while they wait for the processing stages of each of the layers of the video data to be completed. This gives rise to an inefficient use of processing availability of the decoder. A further problem is that the method is limited by the fact that the output of a preceding layer is used for the decoding of a current layer, the output of which is required for the decoding of the subsequent layer and so on. Furthermore, the decoders always wait for a full NAL unit to be decoded before extracting the next NAL unit for decoding, thus increasing their idle time and thus decreasing throughput.

### BRIEF SUMMARY OF THE INVENTION

An object of the present invention is to decrease the amount of time required for the decoding of a video bitstream.

According to a first aspect of the invention, there is provided a decoder for decoding a video data stream that comprises a plurality of video data units. The decoder comprises: a plurality of decoder units configured to carry out a plurality of decoding tasks on said video data units; a video data dispatcher configured to allocate each video data unit to a respective decoder unit in accordance with at least one decoding constraint; and a controller. The controller is configured to:
determine from the decoding constraints which decoding tasks may be performed on a current video data unit;
control the allocation by the video data dispatcher of the current video data unit to a decoder unit based on the determination result; and
perform the determining and controlling step for each video data unit such that a plurality of decoding tasks on a plurality of video data units are carried out in parallel.

According to a second embodiment of the invention, there is provided a method of decoding a video data stream that comprises a plurality of video data units. The method comprises:
extracting a plurality of video data units from the video data stream;
determining what decoding constraints apply to said video data units;
determining which of a plurality of decoding tasks have been performed on the video data units;
determining from the decoding constraints which decoding tasks may be performed on each video data unit; and
allocating the video data units to a plurality of decoder units such that a plurality of decoding tasks on a plurality of video data units are carried out in parallel.

The main advantage of carrying out the plurality of decoding tasks in parallel is that the overall time taken to perform the tasks (and thus decode the video data stream) is reduced.

### BRIEF DESCRIPTION OF THE DRAWINGS

The invention will hereinbelow be described, purely by way of example, and with reference to the attached figures, wherein:

FIG. 1 depicts the architecture of a standard decoder;

FIG. 2 is a schematic diagram of the decoding process of an SVC bitstream;

FIG. 3 is a schematic diagram of the decoding process of individual network abstraction layer units of an SVC bitstream;

FIG. 4 depicts the order of processing of layers of an SVC bitstream;

FIG. 5 depicts the order of processing of layers and of frames of an SVC bitstream;

FIG. 6 depicts the allocation of network abstraction layer units to decoders according to an embodiment of the present invention;

FIGS. 7A and 7B depict the difference in use of processing cores between the state of the art and an embodiment of the present invention;

FIG. 8 is a flow diagram illustrating a method of allocating network abstraction layer units to decoder units according to an embodiment of the present invention;

FIGS. 9 and 10 depict a flow diagram illustrating a method of decoding the network abstraction layer units according to an embodiment of the present invention; and

FIGS. 11 and 12 depict tables showing results of a comparison between a decoding method according to the state of the art and a decoding method according to an embodiment of the present invention.

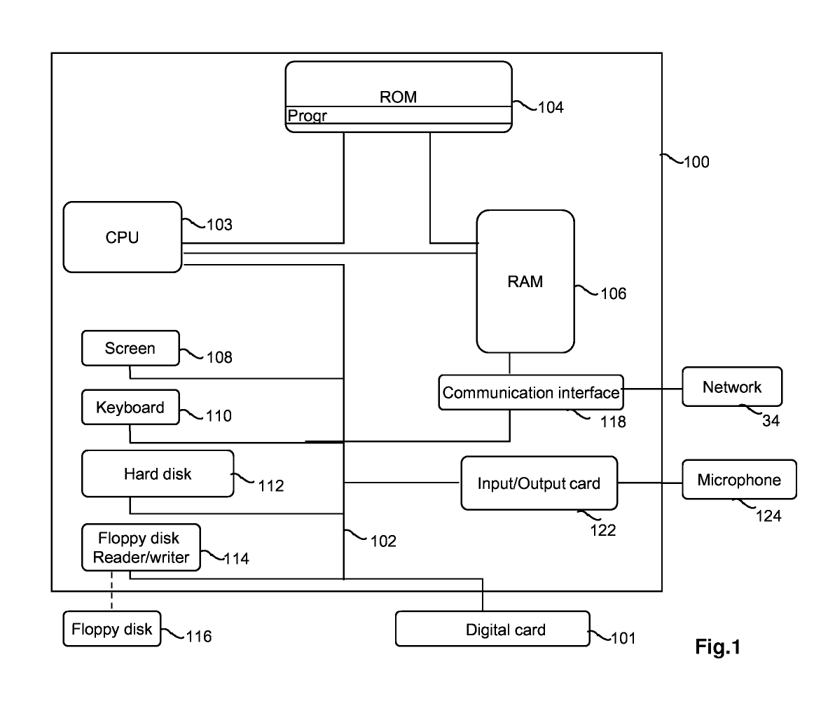

### DETAILED DESCRIPTION OF THE INVENTION

The specific embodiment below will describe the decoding process of a video bitstream that has been encoded using scalable video coding (SVC) techniques. However, the same process may be applied to an H-264/AVC system.

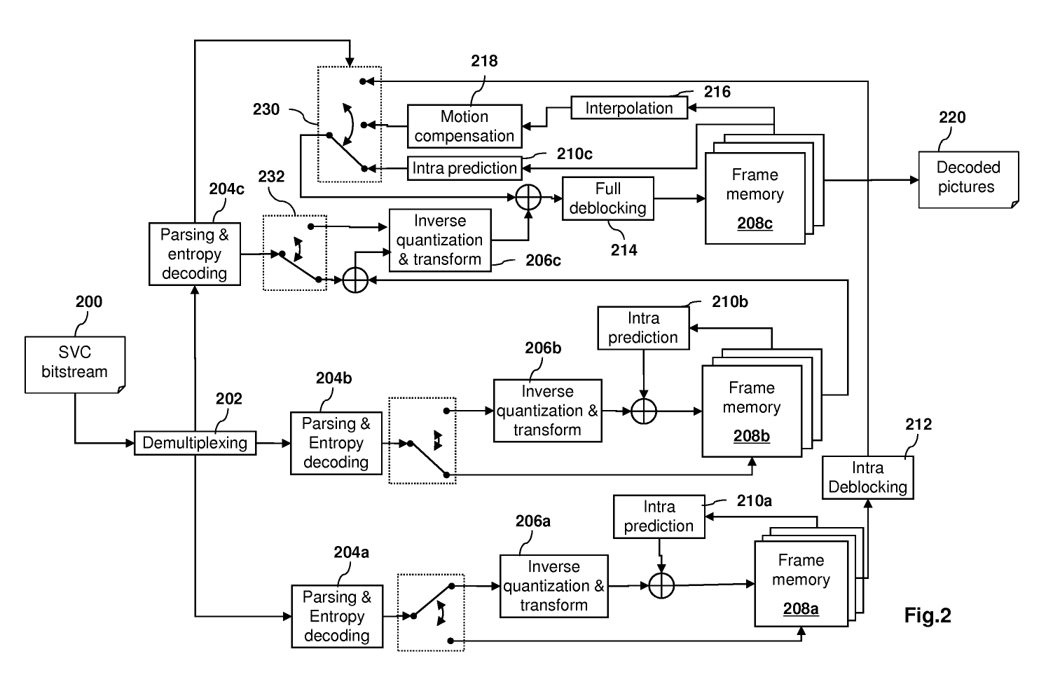

A video data stream (or bitstream) encoder, when encoding a video bitstream, creates packets or containers that contain the data from the bitstream (or information regarding the data) and an identifier for identifying the data that is in the container. As mentioned above, these containers are referred to as video data units. When the video data stream is decoded, the video data units are received and read by a decoder. The various decoding steps are then carried out on the video data units depending on what data is contained within the video data unit. For example, if the video data unit contains base layer data, the decoding processes (or tasks) of stage (a) described above with reference to FIG. 2 will be performed on it.

For the purposes of the present embodiment, the video data units are referred to as NAL units. As described above, each frame or picture of the video data stream is divided into layers. Some of the layers of a frame may be removed in order to keep a lower-quality version of the picture in the frame that uses less bandwidth (i.e. a fewer number of bits) than all of the layers of the frame would if they were all transmitted. The transmission of the number of layers of a frame often includes a compromise between the pictorial quality of the frame and speed of the transmission.

As mentioned above, the layers are divided into elementary units called “network abstraction layer” units. A NAL unit is a syntax structure containing an indication of the type of data contained in the NAL unit as well as the data itself and therefore contains a header with information regarding the NAL unit. The information within the NALU header for the present embodiment will generally contain at least one of the following types of SVC-specific identifier: T_id is a temporal ID; d_id is a dependency ID; and q_id is a quality ID associated with the NALU.

The decoder of this embodiment is an H.264/AVC decoder with the SVC extension capability, referred to hereinafter as an SVC decoder. As mentioned above, such a decoder would until now decode NAL units individually and sequentially. However, it has been noticed that this means that processors experience a large proportion of idle time. As part of a solution to this problem of idle time, the present embodiment uses a multicore processor in the decoder, in which several processes can be executed in parallel in multiple threads. In the description below, the combination of hardware and software that together enables multiple threads to be used for decoding tasks will be referred to as individual decoder units. These decoder units are controlled by a decoder controller that keeps track of the synchronisation of the tasks performed by the decoder units.

However, solving the problem of an inefficiently-used processor is not as straightforward as simply processing more than one NALU simultaneously in different threads. The processing of a video bitstream is limited by at least one strict decoding constraint, as described below. The constraints are generally a result of an output of one decoding task being required before a next task may be performed. A decoding task, as referred to herein, is a step in each of the decoding stages (a,b,c) described above in conjunction with FIG. 2.

As mentioned above, the encoded video bitstream is contained in elementary units called network abstraction layer units (NALU or NAL units). A NALU containing video data may be referred to as nal_unit_type =20, which corresponds to each slice of each layer of each frame, as will be described below. When the bitstream is encoded for transmission, various compression and encoding techniques may be implemented. For ease of description, the decoding of such encoded NAL units will focus on the following four steps or tasks:

1. Parsing and (entropy) decoding;

2. Reconstruction;

3. Deblocking; and

4. Interpolation.

The first three of these four tasks is carried out on each NAL unit in order to decode the NAL unit completely. The fourth step, interpolation, is carried out only on the NAL units of the top-most layer.

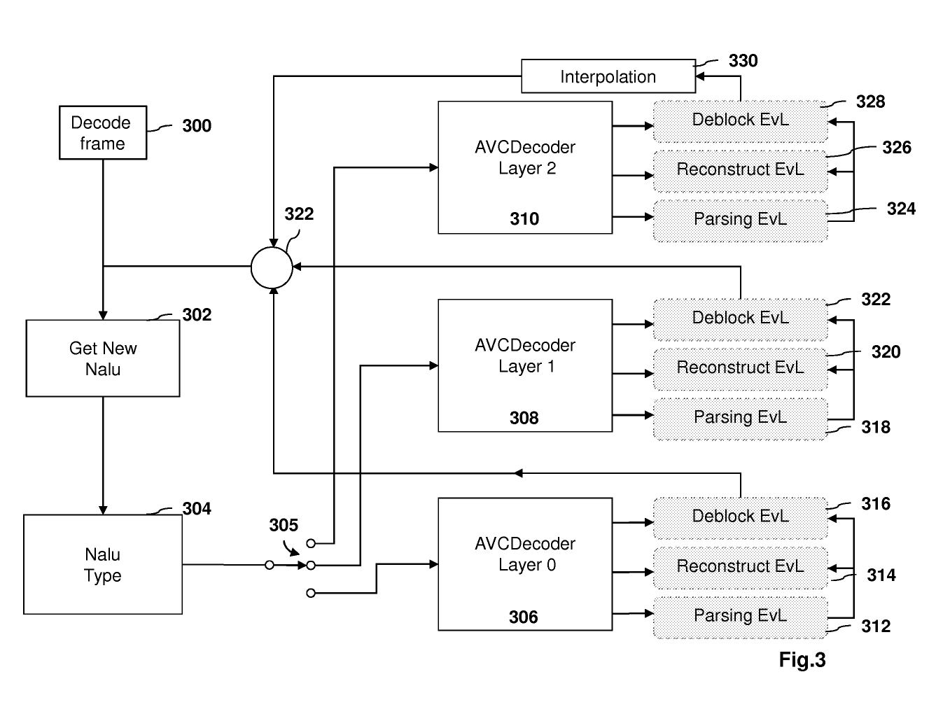

FIG. 3 shows a simplified diagram of the process of FIG. 2, applied to NAL units and to the four particular tasks of decoding that are carried out. FIG. 3 illustrates the decoding process of the NAL units of an SVC stream in a JSVM (Joint Scalable Video Model reference software of the Joint video Team of ISO/IEC MPEG and ITU-T VCEG) software implementation, which is an embodiment of reference software of SVC specifications.

First, a frame of the video bitstream is effectively divided 300 into its component NAL units. Each time a preceding NALU has been decoded, a new NALU is obtained (or extracted) 302 from the video bitstream. A NALU can include several kinds of data which can be coded slice data or parameter data. The NALU is read (in particular, information that is stored in the NALU regarding the slice header is retrieved) and the type of NALU is determined 304. Specifically, in the presently-described implementation, the type of NALU is determined by the nal_unit_type syntax element which is coded on 5 bits, according to “Advanced video coding for generic audiovisual services” of the Telecommunication standardization sector of ITU, 3^{rd} edition, March 2009. This document describes how the data in the NALU may be identified according to the value of this syntax element; in particular, the video data-containing NALU may be identified when the nal_unit_type syntax element value is equal to 14 or 20 and the svc_extension_flag indicates the presence of nal_unit_header_SVC_extension. This latter syntax element is composed of several syntax elements. Among these syntax elements, the dependency_id (“d_id” information described later) described on 3 bits and the quality_id (“q_id” described later) described on 4 bits can be extracted. From these different syntax elements, a unique layer decoder index can be determined by the following formula:

dec_{—}id=(d_{—}id×16+q_{—}id) (1)

If the SVC bitstream contains three layers, three dec_id indexes are determined. The selector switch 305 then sends the NAL units to the corresponding decoder 306, 308, 310 according to the dec_id index. For example, in the case of a three-layer bitstream, all NAL units having the same dec_id will be sent to a first elementary decoder 306, and so on.

More generally, the number of layers within the AU is determined and the NALU is sent to a first AVC decoder 306 in order to have its first layer (Layer 0) decoded. Layer 0 undergoes three steps of decoding, namely parsing & decoding 312, reconstruction 314 and deblocking 316. Once the first layer has finished being decoded, the next layer of the AU (Layer 1) is sent to the decoder 308 for parsing and decoding 318, reconstruction 320 and deblocking 322. Finally, once Layer 1 is decoded, the next layer, Layer 2, is sent to the decoder 310 for parsing and decoding 324, reconstruction 326 and deblocking 328. Once all of the layers are decoded, the last layer may undergo interpolation 330 to give a decoded NALU. In the state of the art, the output of each of the decoders 306, 308 and 310 is not output until all of the layers are decoded (and interpolated, in the case of the top layer), as the NAL units are decoded sequentially. Symbol 322 represents the outputs of the NAL units, which, in the prior art, dictated whether a new NALU could be obtained 302. In the present embodiment, however, there is no restriction at 322 and new NAL units are obtained continuously.

As mentioned above, the decoding tasks cannot simply be carried out in parallel in multiple threads. The decoder has constraints based on the NAL unit processing order (i.e. video data unit processing constraints) and on the capabilities of the decoder, such as number of cores, number of available threads, memory and processor capacity, etc. (i.e. decoder hardware architecture constraints).

The constraints of the decoding process will now be described in greater detail.

### First Constraint: Interlayer Dependencies

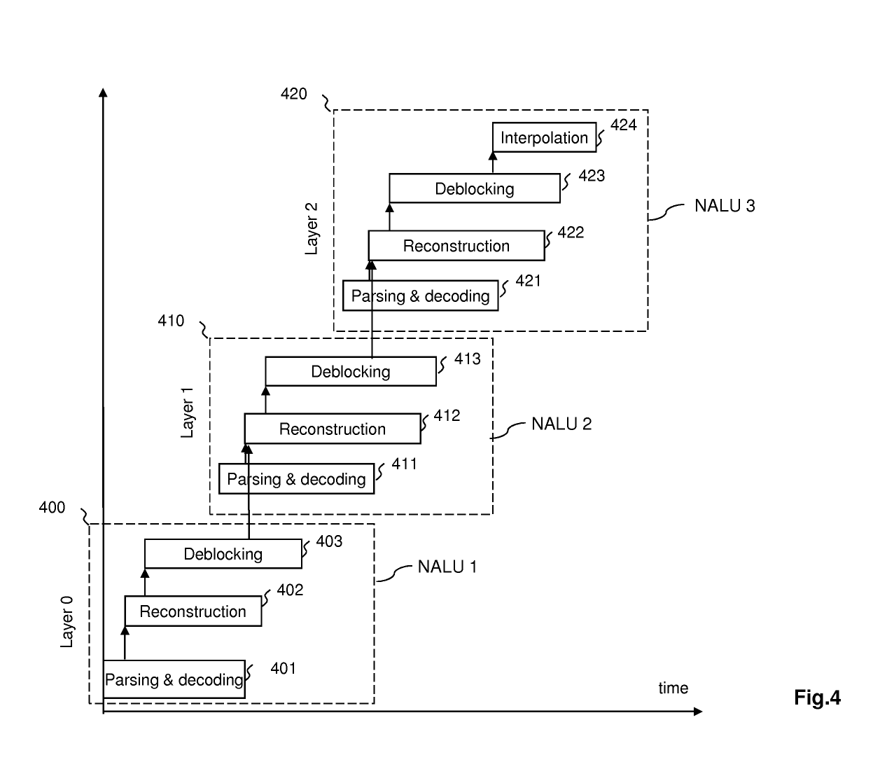

The first constraint regards dependencies within a layer. FIG. 4 illustrates the decoding task dependencies for an Access Unit. These dependencies are given in the SVC standard. An Access Unit is a set of NAL units that are consecutive in decoding order and it contains exactly one coded picture. The decoding of an Access Unit results in a decoded picture. The embodiment illustrated has an Access Unit composed of one slice, itself being composed of three NAL units. In this way, there is one NALU for each layer 400, 410 and 420 within a slice (N.B. the slice may be the same size as a frame).

It is generally accepted that each layer 400, 410 and 420 is decoded only once the previous layer has at least started to be decoded. This is a first constraint associated with SVC decoding. In other words, Layer 1 must follow Layer 0 and Layer 2 must follow Layer 1.

### Second Constraint: Intralayer Dependencies

The second constraint regards dependencies on task order between the layers. There are different decoding steps (generally referred to as tasks or sometimes “sub-tasks”) that are carried out on each NALU (i.e. each layer in FIG. 4) to produce the final decoded picture in an SVC bitstream. These are listed above and shown in FIG. 4 as parsing and decoding 401, 411, 421; reconstruction 402, 412, 422 of the macroblock that will be used for the interlayer prediction; and partial deblocking 403, 413 using a deblocking filter (since only intra coded macroblocks are deblocked in the first two layers). Full deblocking 423 is applied to the top-most layer 420 and this is followed by interpolation 424. This order applies to the three-layer SVC bitstream shown in FIG. 4. Other bitstreams with different numbers of layers will have different dependencies between the layers.

The first and second constraints act together to a certain extent: the three or four decoding steps for each NALU in each layer have to be carried out in a specific order for each layer, and some of the steps are dependent on results of steps having been carried out for previous layers. For example, the reconstruction step 402 of Layer 0 (labelled layer 400 in FIG. 4) is dependent on the result of the parsing and decoding step 401 of the same layer 400 (as shown by an arrow in FIG. 4). The deblocking step 403 is then dependent on the result of the reconstruction step 402. In the next layer 410, which is Layer 1, the reconstruction step 412 is dependent on the result of both the parsing and decoding step 411 of the same layer 410, and also the deblocking step 403 of the previous layer 400. The deblocking step 413 of Layer 1 is dependent on the result of the reconstruction step 412 of the same layer 410. Layer 2 contains the same dependencies on Layer 1 as Layer 1 does on Layer 0. Specifically, the reconstruction step 422 is dependent on the result of the deblocking step 413 of Layer 1 and also on the parsing and decoding step 421 of Layer 2. Again, the deblocking step 423 is dependent on the output of the reconstruction step 422. One difference with the top layer 420 of a NALU compared with the other layers 400 and 410 is that the top layer undergoes a fourth processing step, namely interpolation 424, which is dependent on the final deblocking step 423 of the top layer 420.

### Third Constraint: Frame Dependencies

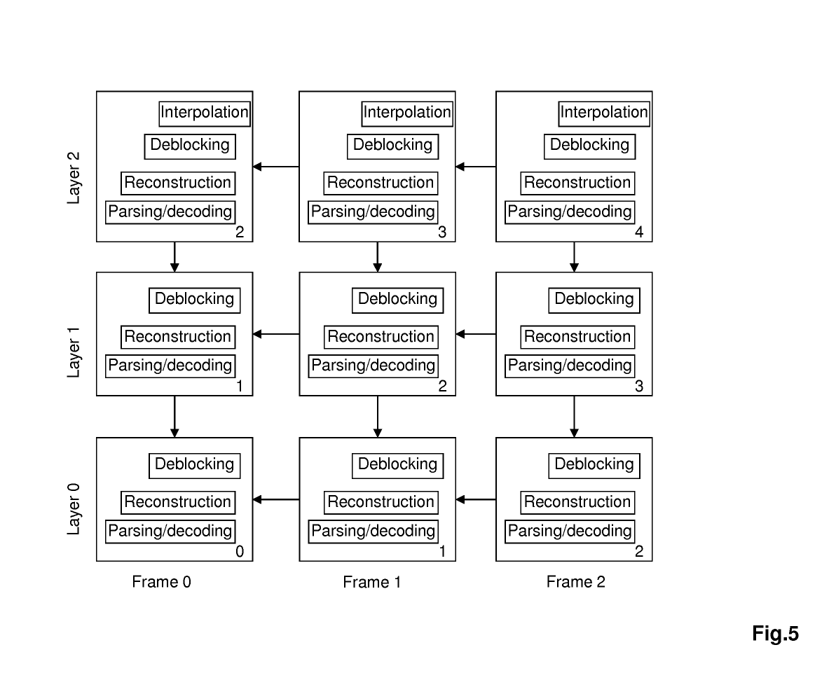

A third constraint faced by the SVC decoder is that the frames of the bitstream must be decoded in a specific order, as well as must the layers of each frame. This is shown schematically in FIG. 5, where Layer 0 of Frame 0 is shown on the bottom left of the diagram, and is the first frame/layer combination that must be decoded. Layer 1 of Frame 0 can only be decoded once Layer 0 of Frame 0 has been decoded, as illustrated by the arrow pointing from Layer 1 of Frame 0 to Layer 0 of the same Frame. Similarly, Layer 0 of Frame 1 can only be decoded once Layer 0 of Frame 0 has been decoded and Layer 1 of Frame 2 can only be decoded once Layer 1 of Frame 1 and Layer 0 of Frame 2 have been decoded.

The present embodiment uses the multiple threads within the multicore PC to decode the SVC bitstreams while respecting the constraints listed above. As described above, despite the constraints related to the order in which the decoding steps can be performed, there are certain freedoms as well, as will be described below.

### First and Second Constraints—Freedoms

In terms of the first and second constraints mentioned above, although layers must be decoded in order, in fact, certain tasks within each layer can be started before the previous layer is completely decoded. For the set of operations 400 shown in FIG. 4 for Layer 0, as soon as a NALU begins to be parsed and decoded, in parallel, the reconstruction operation 402 of that NALU may be started. For example, the delay between the two operations 401 and 402 may be as small as a line of macroblocks. A line of macroblocks is the length of the width of a frame of a video data stream. As soon as a single block within the NALU is parsed and decoded, this block may be reconstructed. However, in a practical implementation and for synchronization efficiency, it is preferable for one line of macroblocks to be parsed and decoded before it is reconstructed. Thus, an entire NALU need not be parsed and decoded before its reconstruction may begin.

With respect to the delay between the reconstruction and the partial deblocking 403, the same may apply such that the delay is only as long as the reconstruction of a line of macroblocks. Thus, decoding tasks may be performed in parallel where there is no dependency. Even where there is dependency, once a decoding task is started, the next, dependent task may also start before the first task is completed for the entire NALU. For example, the parsing of any NALU may occur at any time because it is only the reconstruction that is dependent on a previous NALU deblocking result. Furthermore, the interpolation of the top-most layer may occur at almost any time, though at least one line of macroblocks is preferably fully deblocked before the interpolation is begun.

Layer 1 undergoes the same processes as Layer 0 and the parsing and decoding tasks of Layers 1 and 2 can both start before the completion of the deblocking task 403 because there is no dependency on any other task.

In this way, a second layer can in fact begin to be decoded before the previous one is completely decoded.

### Third Constraint—Freedoms

In terms of the third constraint mentioned above, FIG. 5 shows the dependencies between elementary decoders used for a set of three frames having a single slice each. FIG. 5 shows the frame dependency in addition to the interlayer dependencies discussed above with reference to FIG. 4. The embodiment shown has three NAL units for each Access Unit corresponding to the three layers. The number in the bottom right-hand corner of each frame/layer representative box indicates the processing order of each of these NAL units. For example, the NAL unit that corresponds to Layer 0 of frame 0 must be processed first. Then there are in fact two NAL units that can be processed: the NAL unit of Frame 0/Layer 1 and Frame 1/Layer 0 may be processed in parallel using two decoder units (or “elementary decoders”). For Layer 2, the dependency between frames is limited by the motion compensation process. It is necessary to reconstruct the past frames before compensating the current frame. On the other hand, for Layers 0 and 1, there is no motion compensation process for the reconstruction task, but there does exist a dependency because of specific coding modes in SVC or H.264 such as a “direct” mode. The “direct” mode corresponds to the “horizontal” dependence of decoding task processing; i.e. the dependence of NAL units of consecutive frames of the same layer to be processed in order. In addition, if some motion vectors of Frame 2/Layer 2 are inherited from Frame 2/Layer 1, these motion vectors could be calculated by using the “inheriting” process of motion vectors for the collocated macroblock. The inheriting process is the vertical dependency of a layer on the preceding one.

Even within the above constraints, all parsing and decoding tasks can be performed in parallel because they are not limited by dependency on another task.

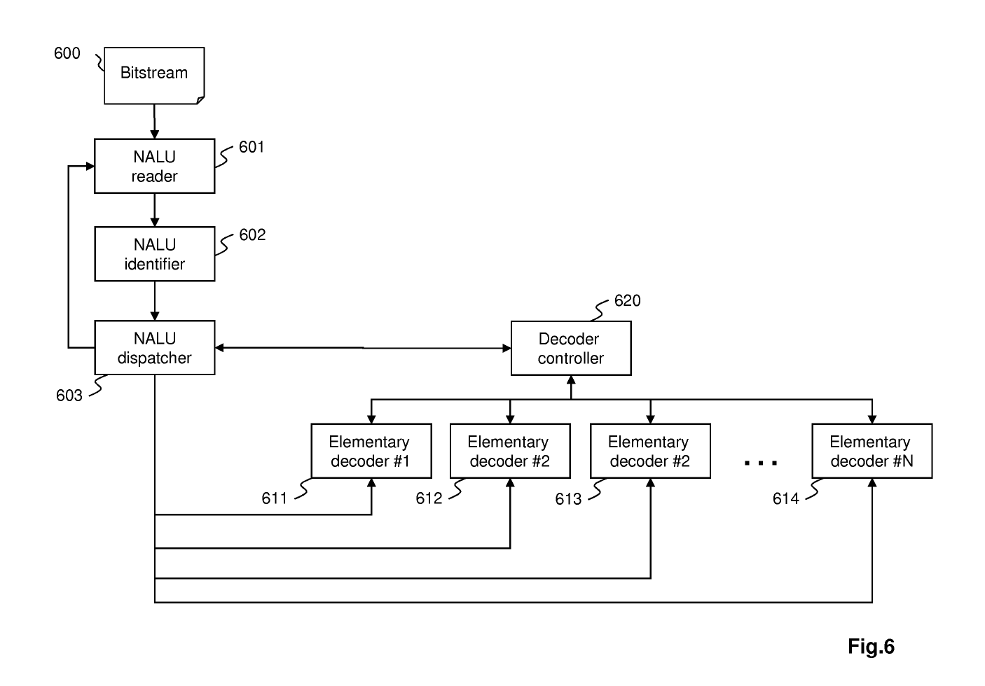

Thus, depending on the NAL unit dependencies and the SVC decoding tasks/steps required for each NAL unit, several of these decoding tasks can be executed in parallel by multiple threads. The architecture of the decoder and the processing logic enable this objective to be achieved by running several decoder units that are synchronized by a decoder controller module. The synchronization refers to the allocation of tasks to appropriate decoder units such that the tasks that can be performed in parallel, are performed in parallel. The allocation of NAL units and decoding tasks to various decoder units is shown in FIG. 6 and described below.

FIG. 6 illustrates the architecture of the present embodiment. This architecture has a different function from a traditional architecture described with reference to FIG. 3. NAL units are not extracted, read and processed in sequence in the present embodiment. Rather, NAL units can be continuously read from the bitstream by the NALU reader module 601.

As shown in FIG. 6, the video bitstream 600 is read by a NALU reader 601, which is configured to read (or extract) the NALU information from the bitstream. The NALU reader 601 or a NALU identifier 602 is configured to identify the type of each NALU, as well as the slice index of the slice containing that particular NALU, if required. In this way, the NALU being read is associated with a dec_id index (i.e. the decoder identifier) as described with respect to step 304 in FIG. 3. The present embodiment is different from the method shown in FIG. 3, however, because an elementary decoder will be allocated for each slice of a given layer of a given frame. A slice index slice_id is thus introduced that can be incremented each time the syntax element first_mb_in_slice=1 in the slice header of the NALU.

The new decoder index dec_id can be determined as follows:

dec_{—}id=(d_{—}id×16+q_{—}id)×MAX_SLICES+slice_{—}id (2)

where MAX_SLICES represents the maximum number of slices of the current frame and could be limited to 32 for example.

In the present example, if the SVC bitstream contains three layers and there are four slices per frame, 12 dec_id indexes are determined for one Access Unit. This means that 12 elementary decoders (or decoder units) will be used for one Access Unit.

Further elementary decoders may be initiated to process several frames in parallel. For example, 48 elementary decoders will enable the decoding of 4 frames in parallel (12 decoders per frame). The number of elementary decoders depends on the bitstream characteristics and, of course, on CPU capacity; i.e. the capability of the CPU to run several threads in parallel.

If the video data stream contains several slices per frame, the slice headers are obtained from the NALU header. This is to obtain the syntax element “first_mb_in_slice”. However, if there is only one slice per frame, the slice header does not need to be checked. In other words, just the header information of the NALU can be read to determine what elementary decoder properties are required to decode that NALU (or, more specifically, to carry out the next decoding task on that NALU). This requires less processing time than also extracting and reading a slice header.

Based on the identified type of NALU, a NALU dispatcher 603 (under the control of the decoder controller module 620) allocates the read NALU to an appropriate AVC (advanced video coding) decoder, also referred to herein as an elementary decoder or decoder unit 611, 612, 613, 614, etc. The appropriate elementary decoder will be one that is capable of carrying out the decoding task required at that moment, and, of course, one that is free (i.e. not busy decoding another NALU). A capability to decode is driven by the decoder being authorized to perform a specific task, for example, because that decoder has access to the result of a previously-performed task that it needs in order to be able to perform the current task.

Elementary decoders are not very different from each other, except that some are able to carry out the interpolation step, so uppermost layer NAL units are allocated to those elementary decoders. The main difference between elementary decoders is that each elementary decoder stores information regarding its previously-decoded NALU, such that subsequent layers are optimally decoded by the same elementary decoder. For instance, the output of the parsing & decoding step of a current NALU is required for the reconstruction step of the same NALU, so the parsing & decoding step result is stored in the elementary decoder for use in the reconstruction step.

The NALU reader is constantly loading (i.e. extracting and reading) NAL units, rather than waiting for each NAL unit to finish its decoding processing. In this way, rather than decoding one NAL unit at a time, parallel processing of several NAL units is possible.

The decoder controller 620 monitors and controls all the statuses of the elementary decoders. If the elementary decoders are occupied by the processing of preceding NAL units, the decoder controller blocks the NALU distribution by the NALU dispatcher until the dedicated decoder is available.

The decoder controller 620 also monitors and controls the internal status of the elementary decoders and authorizes the decoding tasks only if it is possible to do so. This control is illustrated by arrows between the different elementary decoders and the decoder controller in FIG. 6.

Further to this, the decoder controller 620 also monitors the decoding statuses of the NAL units extracted by the NALU reader 601 and controls the NALU dispatcher 603 according to at which stage in the decoding process a particular NALU presently is.

In accordance with the layer and frame dependencies (i.e. the constraints) described above, the decoder controller 620 checks that data to decode the current NALU is available before authorizing the dispatching of the next NALU. For example, data regarding a preceding (or lower) layer is checked to determine whether it has been deblocked before authorization for the reconstruction step of a current layer is given.

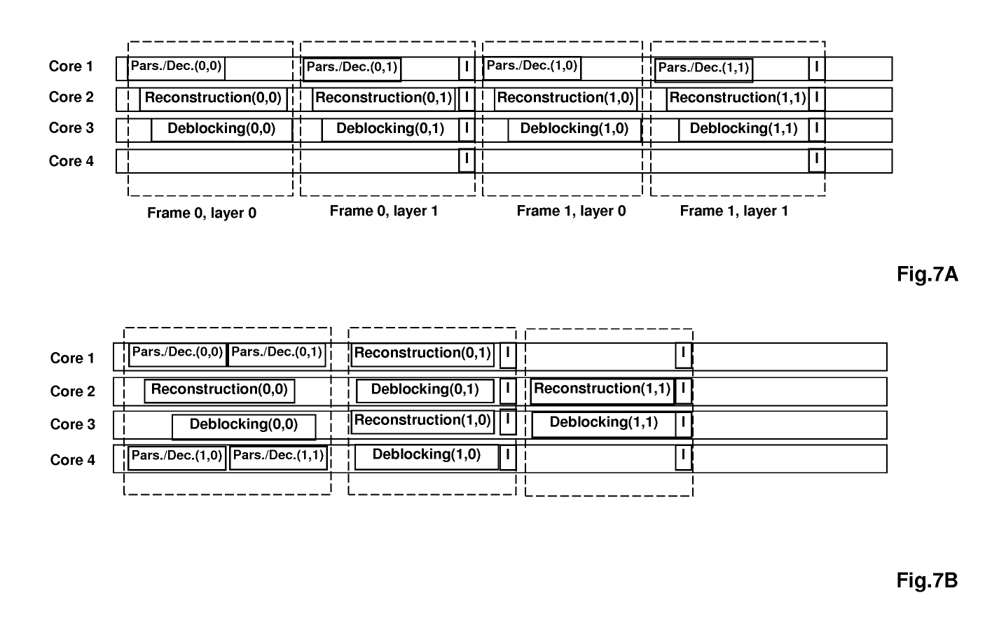

Thus the multicore processor may be efficiently used despite the constraints placed upon it by the SVC specification, as shown in FIGS. 7A and B.

FIG. 7A shows a four-core processor according to the state of the art decoding two layers of two frames. First, Layer 0 of Frame 0 (referred to as (0,0) is parsed (in pars/dec (0,0)), decoded, reconstructed and deblocked. The same is then performed for Layer 1 of Frame 0 (0,1), then Layer 0 of Frame 1 (1,0) and finally, for Layer 1 of Frame 1 (1,1). At the end of each Frame (at the top Layer in each case), the interpolation I is carried out. Each task is carried out in different threads, but the next Layer is only parsed once the previous layer is deblocked. The “dead time” or idle time for each core is shown as blank white time. The fourth core in this case is only used for interpolation “I”.

FIG. 7B, on the other hand, illustrates the allocation of tasks to cores according to the present embodiment. All four cores are more fully used, but for less time. The parsing for all layers occurs at the beginning, as parsing is not dependent on any other task result. This means that the decoding/reconstruction steps may occur earlier and all four cores may be used more efficiently. As mentioned above, Frame 0 Layer 1 (0,1) and Frame 1 Layer 0 (1,0) may be decoded in parallel as they are both dependent on Frame 0 Layer 0 (0,0) having been decoded, but not on each other.

The decoder controller 620 and NALU dispatcher 603 may re-allocate a NALU to the same or a different elementary decoder for each task, depending on which elementary decoder is available and which elementary decoder has access to the result information needed from a previous decoding task to carry out the next task on that NALU. More preferably, the same elementary decoder will perform all tasks for a single NALU so that NALU decoding task result information does not need to be shared amongst the elementary decoders. In this case, the elementary decoders may carry out the decoding tasks using different threads running on the multicore processor, depending on what core is available at the time.

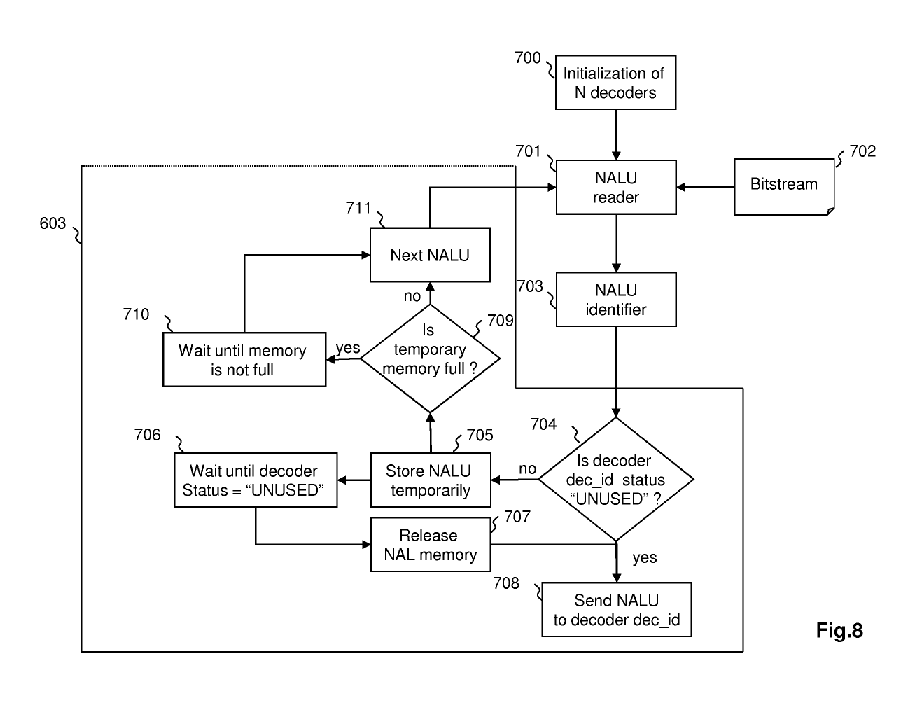

FIG. 8 explain how the NAL units are processed in the new architecture shown in FIG. 6. The box labelled 603 in FIG. 8 represents the NALU dispatcher of FIG. 6.

The first step is that an available number N of decoders are initialized in step 700. The determination of the number N of elementary decoders to be initialized depends on the initial numbers of layers included in the SVC bitstream and the number of slices used per frame as well as the CPU capacity to handle several frames in parallel. For a software application, this number depends on the CPU capacity and especially on the number of cores available for running the different elementary decoders.

NAL units are first read by the NALU reader in step 701 and then identified by the NALU identifier in step 703, similarly to steps 601 and 602 described above. In step 704, a check is performed to determine whether the decoder (“dec_id”) allocated for the currently-read NAL unit has the status: UNUSED. If the response in step 704 is positive, namely, the allocated decoder does indeed have an UNUSED status, the NAL unit is sent directly to that elementary decoder in step 708 to be decoded. On the other hand, if the allocated elementary decoder does not have an UNUSED status, meaning that it is occupied, the NAL unit is temporarily stored in a buffer memory in step 705. The buffer memory is preferably small to store a small number of NAL units. For example, the memory might have a capacity of two or three NAL units per layer. This buffer memory enables the immediate provision of a NALU as soon as the allocated elementary decoder changes its status to UNUSED in step 706. It is the decoder controller 620 that keeps track of the status of each elementary decoder and so the query of the elementary decoder status performed in step 704 is performed through the decoder controller. As soon as the UNUSED status of the allocated elementary decoder is returned, the NAL unit is sent to the allocated elementary decoder (step 708) and the temporary buffer memory that had been used for storing the NAL unit in question is released (i.e. made available) at step 707.

Going back to step 705, where the NAL unit is temporarily stored in the buffer memory, the buffer memory is inspected to determine whether it is full. This inspection may be carried out during the reading process of the current or the next NALU. If the answer to 709 is no, i.e. the buffer memory is not full, the reading (if not already read) and identifying of the next NALU may be carried out in step 711 by the NALU reader and/or the NALU identifier. On the other hand, if the answer to 709 is yes, meaning that the buffer memory is full, the reading and identifying of the next NALU is paused until the NALU memory is no longer full at step 710. This pausing will only last until the NAL unit is released in step 707. Again, it is the decoder controller 620 that is responsible for triggering the transfer of the NALU to the right decoder unit and instructing the NALU dispatcher to release its memory buffer.

A single device may perform the roles of the NALU reader 701, identifier 703 and dispatcher 603, rather than the reader 701 and identifier 703 being separate as shown in FIG. 8.

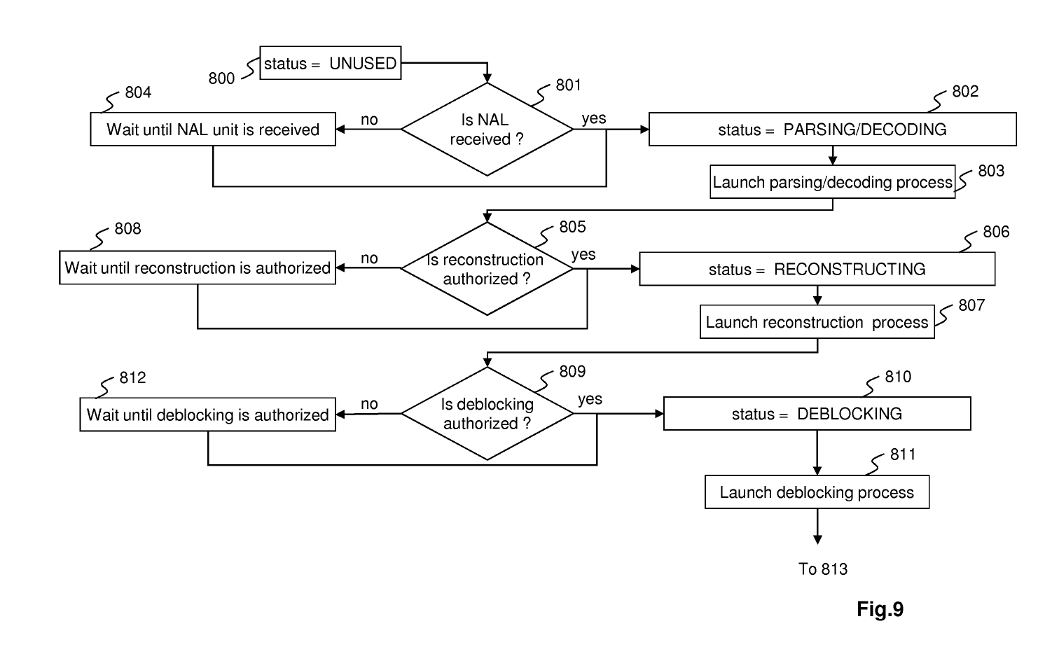

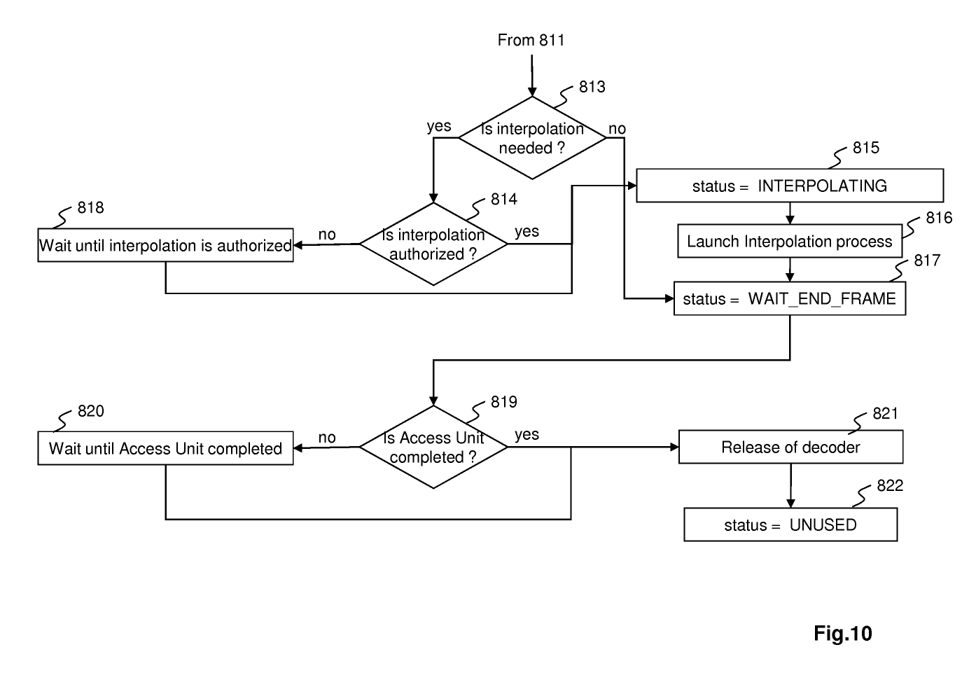

FIGS. 9 and 10 illustrate a flowchart that includes the statuses of an elementary decoder (611, 612, 613 and 614 in FIG. 6) and the processes that occur in dependence on the statuses. Any instantiated elementary decoder has the initial UNUSED status 800.

The decoder controller 620 determines whether a NALU has been received in step 801 and if so (or if it is received after a delay in step 804), the status of the allocated elementary decoder changes to PARSING/DECODING. The parsing of the NALU and the entropy decoding process is performed on the NALU in step 803 in a new thread of the multi-thread processor.

Once the parsing and decoding has been carried out, a check is performed in step 805 to determine whether reconstruction of the NALU has been authorized. This step 805 is performed by the decoder controller 620, which verifies if it is possible to perform the reconstruction process and authorizes it if so. For example, if the current NALU corresponds to a NALU of Layer 1, the decoder controller checks if corresponding NAL units of the lower Layer 0 are already deblocked and ready to be used. In other words, the decoder controller determines that the relevant constraints of the system are satisfied such that the NALU is ready to be reconstructed. If the response to step 805 is positive (or is positive after a delay in step 808) such that reconstruction of the NALU is authorized, the status of the elementary decoder is changed to RECONSTRUCTING and the reconstruction process is launched 807 in a new thread.

The reconstruction process includes the generation of reconstructed blocks of the current NALU. It covers the interlayer prediction, which includes the Intra-prediction, motion vector prediction and residual prediction between layers. The reconstruction process also includes motion compensation and inverse quantization and inverse transform operations described above. The different operations depend on the coding mode of each macroblock of the current NALU.

Immediately after the reconstruction process is launched 807, the decoder controller 620 determines whether to authorize the deblocking process in step 809. When the response to step 809 is positive (or is positive after a delay in step 812) such that the deblocking process is authorized, the status of the elementary decoder is changed to DEBLOCKING 810 and the deblocking process is started 811 immediately in a new thread. A partial or a full deblocking process is performed depending on whether the NAL unit belongs to the top-most layer or not.

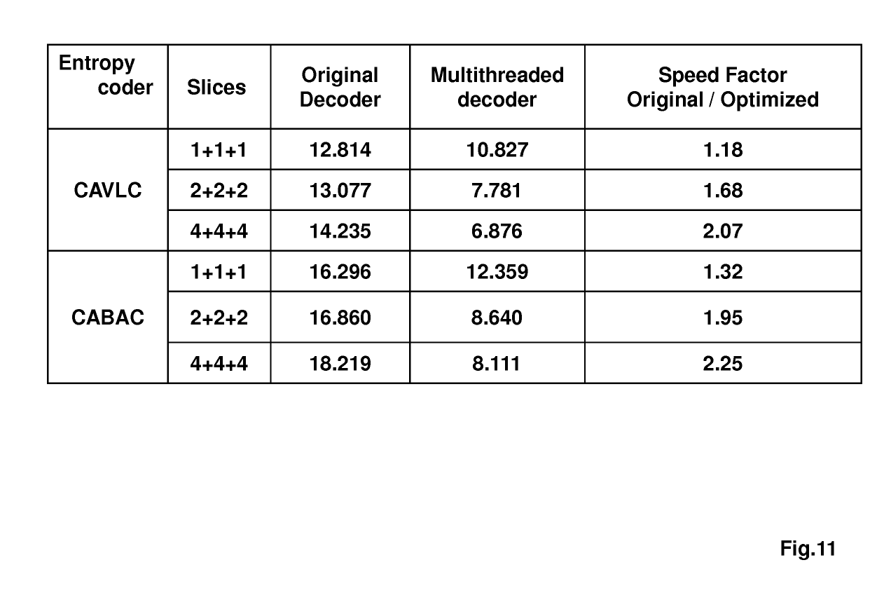

After the deblocking process 811 has started, the next step 813 (shown on FIG. 11) consists of checking if the interpolation process is required. The interpolation process is only performed on NAL units of the top-most layer where the motion compensation is performed.

Preferably, the elementary decoders contributing to the reconstruction and decoding of an AU are not released before the full reconstruction of the image in that AU. For example, the elementary decoder for Frame 0/Layer 1 and Frame 1/Layer 0 is preferably not released before the full reconstruction of Frame 0/Layer 2, as this frame may need (through interlayer prediction) some video data that is stored in the elementary decoder of Frame 0/Layer 0. Thus, if interpolation is not required, the elementary decoder changes its status to WAIT_END_FRAME in step 817.

On the other hand, if the NALU is to undergo interpolation (i.e. the NALU is of the top-most layer), a check is carried out to determine if interpolation is authorized in step 814. If the decoder controller authorizes the interpolation 814 (also if the authorization is after a delay 818), the status of the elementary decoder is changed to INTERPOLATING 815 and the interpolation process is started 816 in a new thread.

Finally, after the interpolation process is performed (if appropriate), a check is performed in step 819 to determine if the decoding process of the entire Access Unit has been completed. If so (including after a delay 820), the current elementary decoder is released 821 because the decoding and the reconstruction of the Access Unit have been performed. The status of the elementary decoder is thus changed back to UNUSED 822 and the elementary decoder is available for decoding further NAL units, for example, of the same layer of the video data.

FIG. 11 shows a result table comparing the decoding time (in seconds) of some SVC video bitstreams of an SVC decoder according to the present embodiment with that of the prior art. The main result of the present embodiment is to improve the decoding speed of the SVC decoder compared with the sequential decoding approach of the prior art. To obtain the results in FIG. 11, the embodiment is implemented in an existing SVC decoder. The decoding time results given in FIG. 11 were obtained on a PC (personal computer) using an Intel™ Xeon™ processor with 4 cores running at 3 GHz. Two types of entropy coder were used: CAVLC (“Context Adaptive Variable Length Coding”) and CABAC (“Context Adaptive Binary Arithmetic Coding”). The results illustrate the decoding times (in seconds) and speed factor performance obtained on a 3-layer SVC stream. The “slices” column lists the number of slices present in each layer of the video data. 1+1+1 means that there is one slice in each of three layers. 2+2+2 means that there are two slices in each of three layers, and so on. As can be seen from the table, the decoding process of a decoder according to the present embodiment is up to 2.25 times faster than SVC streams where all processing tasks are carried out on a NALU before the next NALU is read. Implementing the present embodiment in an 8-core processor enables a further 2 times gain in speed efficiency.

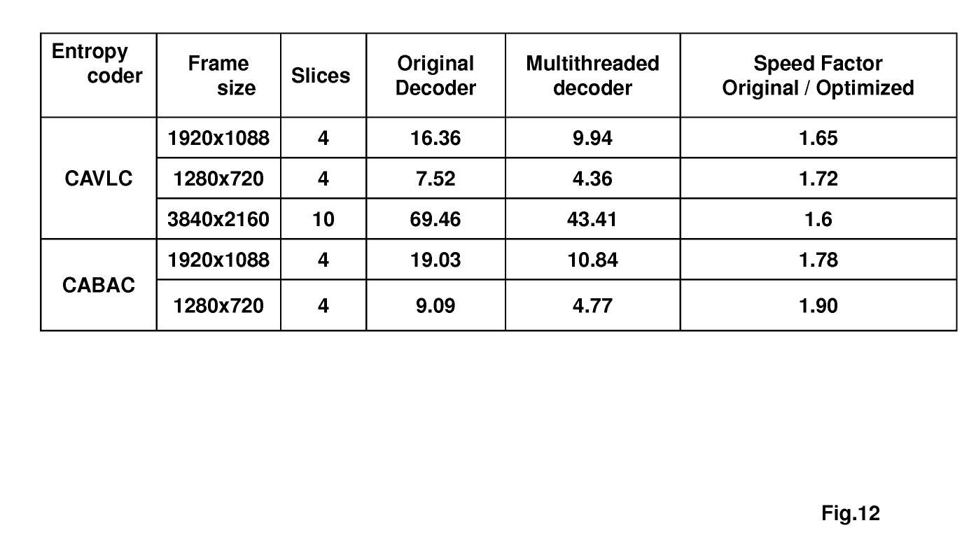

FIG. 12 illustrates a performance table for decoding carried out according to the present embodiment on pure H.264 streams, without the SVC specification. As can be seen from the table, the decoding process of a decoder according to the present embodiments with the multicore processor works well on pure H.264 streams, with a maximum improvement of 1.9 times gain in speed efficiency.

The present embodiment thus enables a processor to reduce sequential decoding tasks considerably and to carry out decoding tasks in parallel while respecting SVC (or H.264/AVC, where the SVC specification is not used in coding the video data) constraints. A decoding task is performed as soon as it is possible to perform it, and in a non-intuitive order, rather than waiting for the previous NALU to be completely processed.

### Modifications

The flowchart of FIGS. 9 and 10 illustrates a single embodiment of the architecture and functioning of the present invention. However, the skilled person would be able to implement the basic invention with different approaches while respecting the SVC specifications.

Rather than reading the header of each NALU to determine the type of NALU (q, d and T identifiers), the slice header may be read. This usually takes more time, but gives a larger amount of information (i.e. I, B and P frames and NALU dependency). Nevertheless, it is preferable to obtain the NALU type, slice index and layer index from each NAL unit (in the case of SVC-type encoding having been used on the video data) because of the reduction of time taken achievable.

The skilled person may be able to think of other modifications and improvements that may be applicable to the above-described embodiment. The present invention is not limited to the embodiments described above, but extends to all modifications falling within the scope of the appended claims.

What is claimed is:

1. A decoder for decoding a video data stream that comprises a plurality of video data units, the decoder comprising:
a plurality of decoder units configured to carry out a plurality of decoding tasks on said video data units;
a video data dispatcher configured to allocate each video data unit to a respective decoder unit in accordance with at least one decoding constraint; and
a controller configured to:
determine from the decoding constraints which decoding tasks may be performed on a current video data unit;
control the allocation by the video data dispatcher of the current video data unit to a decoder unit based on the determination result; and
perform the determining and controlling step for each video data unit such that a plurality of decoding tasks on a plurality of video data units are carried out in parallel.

2. A decoder according to claim 1, wherein a decoding constraint comprises an order in which the video data units within a predetermined set of video data units are decoded, and
the controller is configured to control the video data dispatcher to allocate a current video data unit to a first decoder unit for decoding if the first decoder unit is available at a time after which a preceding video data unit within the predetermined set has started being decoded.

3. A decoder according to claim 2, wherein the predetermined set comprises one of a macroblock, a slice, a frame or a picture within the video data stream.

4. A decoder according to claim 1, wherein a decoding constraint comprises an order in which decoding tasks are to be performed on a single video data unit, and
the controller is configured to control the video data dispatcher to allocate a current video data unit to a first decoder unit depending on:
which decoding tasks have been performed on the current video data unit; and
the availability of a decoder unit at the time when the next decoding task in the current video data unit is due to be performed.

5. A decoder according to claim 4, wherein the video data unit dispatcher is configured to allocate a video data unit to the same decoder unit for two or more of the decoding tasks to be performed on said video data unit.

6. A decoder according to claim 1, wherein a decoding constraint comprises a second specific decoding task of a second video data unit having to follow a first specific decoding task of a first video data unit; and
the controller is configured to control the video data dispatcher to allocate the second video data unit to an available decoder unit at a moment when the first specific decoding task is complete.

7. A decoder according to claim 6, wherein, when a decoder unit is not available, the decoder controller is configured to store the second video data unit until a decoder unit becomes available.

8. A decoder according to claim 1, wherein said at least one decoding constraint is at least one of a video data unit processing constraint and a decoder hardware architecture constraint.

9. A decoder according to claim 1, adapted to decode a video data stream that is encoded according to a scalable format comprising at least two layers, the decoding of a second layer being dependent on the decoding of a first layer, said layers being composed of said video data units and the decoding of at least one of said video data units being dependent on the decoding of at least one other video data unit, wherein
said controller is configured to:
monitor a decoding status of each video data unit;
monitor an availability status of each decoder unit; and
when the decoding status of a current video data unit indicates that said at least one video data unit on which the decoding of the current video data unit depends has been decoded, and when the availability status of a first decoder unit indicates that the decoder unit is available to decode, cause the allocation of the current video data unit to the first decoder unit.

10. A decoder according to claim 9, wherein
said video data dispatcher is configured to analyze the dependency of a current video data unit on other video data units, and,
when all video data units on which the current video data unit depends have been decoded, said video data dispatcher is configured to output the decoding status, indicating that the video data units have been decoded, of the said video data units to said controller.

11. A decoder according to claim 9, wherein
said video data dispatcher is configured to:
analyze decoding constraints applicable to a decoding task to be performed next on a current video data unit;
when the decoding constraints are satisfied, update a decoding status of said current video data unit; and
notify the updated decoding status to said decoder controller, and
said decoder controller is configured to authorize the video data dispatcher to allocate said current video data unit to an available decoder unit to perform said next decoding task.

12. A decoder according to claim 9, wherein the decoder is an SVC decoder.

13. A decoder according to claim 1, wherein the plurality of decoding tasks may be carried out by different decoder units in different threads using a multicore processor.

14. A decoder according to claim 1, wherein the video data dispatcher is further configured to read a header of each video data unit to determine a type of each respective video data unit, the type of video data unit indicating the dependency of the decoding of the video data unit on the decoding status of preceding video data units, and to allocate each type of video data unit to a decoder unit that is capable of decoding the determined video data unit type.

15. A decoder according to claim 1, further comprising a multicore processor, wherein said video data dispatcher is further configured to allocate different decoding tasks of a single video data unit to different threads made available by the multicore processor.

16. A decoder according to claim 1, further comprising a decoder controller configured to control the allocation of decoding tasks to the plurality of decoder units.

17. A decoder according to claim 1, wherein the video data units are Network Abstraction Layer Units of the video data stream.

18. A decoder according to claim 1, wherein the video data units are video data stream frames.

19. A decoder according to claim 1, wherein the video data units are layers of each frame of the video data stream.

20. A decoder according to claim 1, wherein the video data units are blocks or macroblocks of the video data stream.

21. A method of decoding a video data stream that comprises a plurality of video data units, the method comprising:
extracting a plurality of video data units from the video data stream;
determining what decoding constraints apply to said video data units;
determining which of a plurality of decoding tasks have been performed on the video data units;
determining from the decoding constraints which decoding tasks may be performed on each video data unit; and
allocating the video data units to a plurality of decoder units such that a plurality of decoding tasks on a plurality of video data units are carried out in parallel.

22. A method according to claim 21, wherein
the decoding constraints include at least one of:
an order in which the plurality of video data units are to be decoded;
an order in which decoding tasks are to be performed on a single video data unit; and
a dependency of a decoding task to be performed on a second video data unit on a decoding task to be performed on a first video data unit, and
said step of allocating the video data units to said plurality of decoder units comprises determining whether a specific decoding task may be performed on a specific video data unit in accordance with at least one of the constraints; determining whether a decoder unit is available for performing the specific decoding task; and allocating the specific video data unit to the decoder unit when the result of the two determination steps are positive.
